(19) United States
(12) Patent Application Publication
(10) Pub. No.: US 2006/0001260 A1
(43) Pub. Date: Jan. 5, 2006

(54) Fluid vortex manifold

(76) Inventor: David M. Thompson, Bricktown, NJ (US)

Correspondence Address: Andrew W. Ludy, 17 Sherwood Way, Landing, NJ, 07850, US

(21) Appl. No.: 10/881,904

(22) Filed: Jun. 30, 2004

(51) Int. Cl. F16L 39/00

(52) U.S. Cl. 285/125.1

(57) ABSTRACT

A fluid vortex manifold is for use in connection with a fluid drain plumbing system having a plurality of fluid sources and a fluid receptacle. A hollow circular cylindrical shell includes a periphery, a shell central axis, and a chamber adapted to receive the fluid material. A plurality of peripheral inlets, each having a diameter less than the shell diameter, is disposed around the shell periphery. The peripheral inlets are generally tangential to, and communicate with the shell chamber. The peripheral inlets are adapted to receive fluid material and direct it tangentially into the shell chamber, forming a vortex and suction, so as to preclude a backflow of the fluid material through the peripheral inlets. Each peripheral inlet has an inlet central axis. The shell central axis and the inlet central axis define skew lines. A single outlet is adapted to discharge all of the fluid material from the chamber. Pipe threads preferably connect the peripheral inlets to the fluid sources, and connect the shell outlet to the fluid receptacle. The manifold is preferably molded in one piece from a polymeric resin.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

This invention relates to the field of fluid manifolds, and more particularly to a vortex-inducing drain manifold for collecting and draining fluid from several sources simultaneously.

In plumbing installations aboard boats, drained fluid material must eventually be directed to a receptacle, such as a through-hull fitting for discharge, or a holding tank. Fluid material is defined hereby to include mostly liquids, but can include some gases and solid particles in any combination. Many different appliances are found on a large boat, such as a bait tank, a sink and icebox drain in the galley (kitchen), and a sink and shower in each head (bathroom). Appliances located at different parts of the boat must either be connected together, or be connected to several through-hull fittings. Multiple through-hull fittings pose a problem in potential leakage that at best is annoying, and at worst can sink the vessel. Connecting the appliances together is often the best solution. This poses a problem with multiple plumbing connections, tees, cross fittings, nipples, etc., in a limited and enclosed space. One solution is to fabricate a plumbing fitting having multiple inlets to a hollow shell, which connects to the through-hull fitting. This solves the limited space problem. However, when several appliances are in use simultaneously, fluid material enters the hollow shell from multiple inlets at one point and at one time. This can result in fluid material backing up one or more of the drains, or draining slowly from each one. This problem is solved by the present invention by attaching the inlets tangentially to the shell. Fluid material entering the shell is directed to circulate around the inner periphery of the shell, producing a vortex. The vortex causes suction that induces fluid material to drain from the several appliances, and prevents the fluid material from backing up. Vortex and cyclone chambers are known, and have taken a variety of configurations in the past. Some vortex chambers are seen in the following prior art patents:

Hyde, U.S. Pat. No. 5,866,018, and Hartmann, U.S. Pat. No. 6,398,969, each show a circular cylindrical vortex chamber with one tangential inlet, and axial outlets on the top and the bottom. Water enters the inlet, creating a vortex. Solid particles exit the bottom, and water exits the top.

Jensen, U.S. Pat. No. 6,238,110, depicts a circular cylindrical vortex chamber with multiple tangential inlets and one axial overflow outlet on the bottom. One gas vent is located transversely near the top. One liquid outlet and one drain are disposed transversely near the bottom.

Kistner, U.S. Pat. No. 6,547,962, discloses a circular cylindrical vortex chamber with one tangential inlet and one axial outlet that turns and exits transversely. Solids collect on the chamber bottom, and liquid exits the chamber.

Armacost, U.S. Pat. No. 1,975,494, shows a circular cylindrical header with a plurality of inlet pipes that enter the header off center, but not tangentially. As a steam superheater, the Armacost device does not, and must not create a vortex.

Hyde, Hartmann, and Kistler are intended to separate suspended solids from a liquid. Jensen separates gasses from a liquid. Armacost is a mechanical expedient to clamp a tube removably to a header. None of the prior-art devices disclose several sources of a fluid material entering a cylindrical body tangentially to create a vortex, and exiting the body downward by gravity flow through a single outlet. None of the prior-art devices are adapted to preclude backflow of fluid material through the inlets. None of the above devices are easily connected to the fluid material sources with standard fittings.

Accordingly, there is a need to provide a fluid vortex manifold that will collect fluid material at one point from a plurality of sources.

There is a further need to provide a fluid vortex manifold of the type described and that will create a vortex so as not to allow fluid material to flow back up one of the sources.

There is a yet further need to provide a fluid vortex manifold of the type described and that will fit in a confined space.

There is a still further need to provide a fluid vortex manifold of the type described and that will be easily installed with hand tools.

There is another need to provide a fluid vortex manifold of the type described and which is easily connected to the fluid sources with standard fittings.

There is yet another need to provide a fluid vortex manifold of the type described and that can be manufactured cost-effectively in large quantities of high quality.

### BRIEF SUMMARY OF THE INVENTION

In accordance with the present invention, there is provided a fluid vortex manifold for use in connection with a fluid material drain plumbing system. The drain system has a plurality of fluid sources supplying fluid material including liquids, gases, and solid particles. The fluid vortex manifold comprises a hollow circular cylindrical shell extending between top and bottom ends. The shell has a predetermined diameter, a periphery, a shell central axis, a chamber adapted to receive the fluid material, and a single outlet at the bottom end. The outlet is adapted to discharge all of the fluid material from the chamber.

A plurality of hollow circular cylindrical peripheral inlets is disposed around the shell periphery. The peripheral inlets have a diameter less than the shell predetermined diameter. The peripheral inlets are generally tangential to the shell. The peripheral inlets each have an inlet central axis. The shell central axis and the inlet central axis define skew lines. The inlet central axis of each peripheral inlet is in the same-handed relation to the shell central axis when viewed along the shell central axis. The peripheral inlets communicate with the shell chamber. The peripheral inlets are adapted to receive fluid material from the fluid sources and direct the fluid material tangentially into the shell chamber, forming a vortex and suction. This is to preclude a backflow of the fluid material through the peripheral inlets. The fluid vortex manifold is preferably molded in one piece from a polymeric thermoplastic or thermoset resin. Alternative materials include iron, carbon steel, stainless steel, copper, brass, bronze, monel, aluminum and concrete.

Inlet connecting means is provided for connecting the peripheral inlets to the fluid sources. Similarly, outlet connecting means is provided for connecting the shell outlet to the fluid receptacle.

### BRIEF DESCRIPTION OF THE SEVERAL VIEWS OF THE DRAWING

A more complete understanding of the present invention may be obtained from consideration of the following description in conjunction with the drawing, in which:

FIG. 1 is a perspective view of a first embodiment of a fluid vortex manifold constructed in accordance with the invention;

FIG. 2 is a top view of the fluid vortex manifold of FIG. 1;

FIG. 3 is a front elevational view of the fluid vortex manifold of FIG. 1;

FIG. 4 is a front cross-sectional elevational view of the fluid vortex manifold of FIG. 1, taken along lines 4-4 of FIG. 2;

FIG. 5 is a front elevational view of the fluid vortex manifold of FIG. 1;

FIG. 6 is a top cross-sectional view of the fluid vortex manifold of FIG. 1, taken along lines 6-6 of FIG. 5;

FIG. 7 is a perspective view of a second embodiment of a fluid vortex manifold constructed in accordance with the invention;

FIG. 8 is a top view of the fluid vortex manifold of FIG. 7;

FIG. 9 is a front elevational view of the fluid vortex manifold of FIG. 7;

FIG. 10 is a front cross-sectional elevational view of the fluid vortex manifold of FIG. 7, taken along lines 10-10 of FIG. 8;

FIG. 11 is perspective view of a third embodiment of a fluid vortex manifold constructed in accordance with the invention;

FIG. 12 is a top view of the fluid vortex manifold of FIG. 11;

FIG. 13 is a front elevational view of the fluid vortex manifold of FIG. 11;

FIG. 14 is a front cross-sectional elevational view of the fluid vortex manifold of FIG. 1, taken along lines 14-14 of FIG. 12;

FIG. 15 is perspective view of a fourth embodiment of a fluid vortex manifold constructed in accordance with the invention;

FIG. 16 is a top view of the fluid vortex manifold of FIG. 15;

FIG. 17 is a front elevational view of the fluid vortex manifold of FIG. 15;

FIG. 18 is a front cross-sectional elevational view of the fluid vortex manifold of FIG. 15, taken along lines 18-18 of FIG. 16;

FIG. 19 is perspective view of a fifth embodiment of a fluid vortex manifold constructed in accordance with the invention;

FIG. 20 is a top view of the fluid vortex manifold of FIG. 19;

FIG. 21 is a front elevational view of the fluid vortex manifold of FIG. 19;

FIG. 22 is a front cross-sectional elevational view of the fluid vortex manifold of FIG. 19, taken along lines 22-22 of FIG. 20;

FIG. 23 is perspective view of the first and fifth embodiments of the fluid vortex manifold, assembled together;

FIG. 24 is perspective view of a sixth embodiment of a fluid vortex manifold constructed in accordance with the invention;

FIG. 25 is a top view of the fluid vortex manifold of FIG. 24;

FIG. 26 is a front elevational view of the fluid vortex manifold of FIG. 24; and

FIG. 27 is a front cross-sectional elevational view of the fluid vortex manifold of FIG. 24, taken along lines 27-27 of FIG. 25.

### DETAILED DESCRIPTION OF THE INVENTION

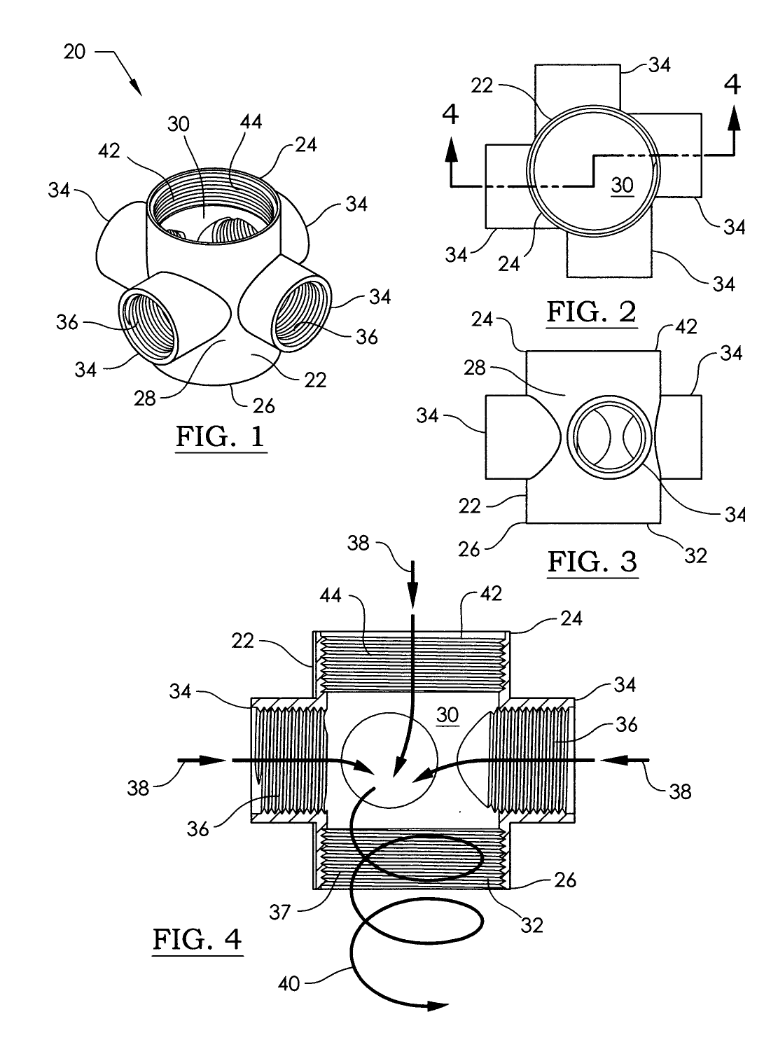

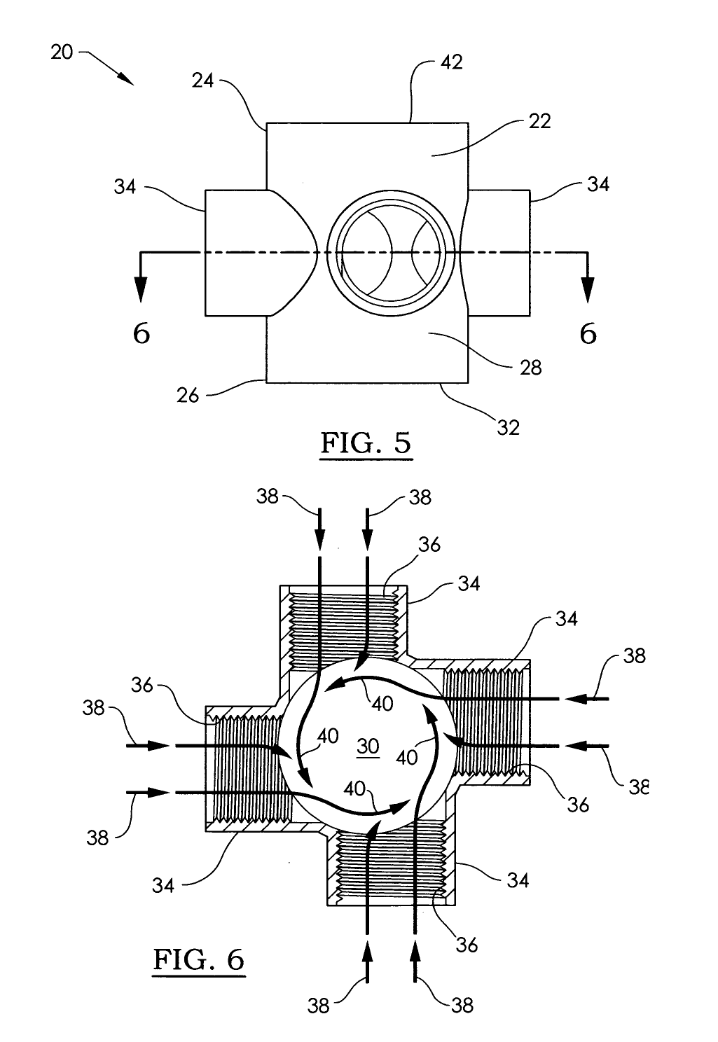

Referring now to the drawing, and especially to FIGS. 1 through 6 thereof, a first embodiment of a fluid vortex manifold constructed in accordance with the invention is shown at 20, and is for use in connection with a fluid drain plumbing system (not shown). In particular, the vortex manifold 20 is intended for use on a boat, wherein the available space for plumbing fittings is, at best, limited. The drain system has a plurality of fluid sources (not shown) such as sinks and showers, supplying fluid material including liquids, gases, and solid particles. The drain system has at least one receptacle (not shown) such as a through-hull fitting, or a holding tank, for receiving the fluid material from the fluid sources. The fluid vortex manifold 20 comprises a hollow circular cylindrical shell 22 extending between top 24 and bottom 26 ends. The shell 22 has a predetermined diameter, a periphery 28, a shell central axis, and a chamber 30 adapted to receive the fluid material. The shell 22 has a top inlet 42 at the top end 24, and a single outlet 32 at the bottom end 26. The outlet 32 is adapted to discharge all of the fluid material from the chamber 30. The prior-art inventions, by contrast, employ multiple outlets adapted to discharge different materials separated from one another.

A plurality of hollow circular cylindrical peripheral inlets 34 is disposed around the shell periphery 28. The peripheral inlets 34 have a diameter less than the shell predetermined diameter. The peripheral inlets 34 are generally tangential to the shell 22, and communicate with the shell chamber 30. The peripheral inlets 34 are adapted to receive fluid material from the fluid sources and direct the fluid material tangentially into the shell chamber 30, forming a vortex and suction, so as to preclude a backflow of the fluid material through the peripheral inlets 34. Each peripheral inlet 34 has an inlet central axis. The shell central axis and the inlet central axis define skew lines, meaning they are not parallel, do not intersect, and do not lie in the same plane. The inlet central axis of each peripheral inlet 34 is in the same-handed relation to the shell central axis when viewed along the shell central axis. This means that in the top view, FIG. 2, all of the peripheral inlets 34 enter the shell 22 in a counterclockwise direction. Thus, fluid material from each peripheral inlet 34 rotates in the same direction to create the vortex. It is to be understood that the peripheral inlets 34 can enter the shell 22 in a clockwise direction.

In the preferred embodiment, the fluid vortex manifold 20 is molded in one piece from a polymeric thermoplastic or thermoset resin. It is to be understood that other materials would also be appropriate, such as iron, carbon steel, copper, and brass. For marine use, stainless steel, bronze, and monel are preferred, along with the resins. For municipal systems, aluminum and concrete are appropriate.

Inlet connecting means are provided for connecting the peripheral inlets 34 to the fluid sources. Typically, the inlet connecting means are female pipe threads 36 at the peripheral inlets for attaching threaded plumbing fittings (not shown) to the peripheral inlets 34. Similarly, outlet connecting means are provided for connecting the shell outlet 32 to the fluid receptacle. Preferably, the outlet connecting means are female pipe threads 37 at the shell outlet 32 for attaching threaded plumbing fittings (not shown) to the shell outlet 32. In operation, fluid material, shown by arrows 38, will flow from the fluid sources through the peripheral inlets 34 and enter the shell chamber 30 tangentially. Fluid material 38 entering the shell chamber 30 is directed to circulate around the inner periphery 28 of the shell chamber 30, producing a vortex about the central axis, shown by arrows 40. The vortex 40 causes suction that induces the fluid material 38 to drain from the several appliances, and prevents the fluid material 38 from flowing backward up to the sources. Fluid material 38 will then flow out of the shell chamber 30 through the outlet 32 into the fluid receptacle.

The shell 22 further comprises a top inlet 42 at the top end 24. Female pipe threads 44 are provided at the top inlet 42 for attaching a threaded plumbing fitting (not shown) to the top inlet 42 so as to connect the top inlet 42 to one of the fluid sources.

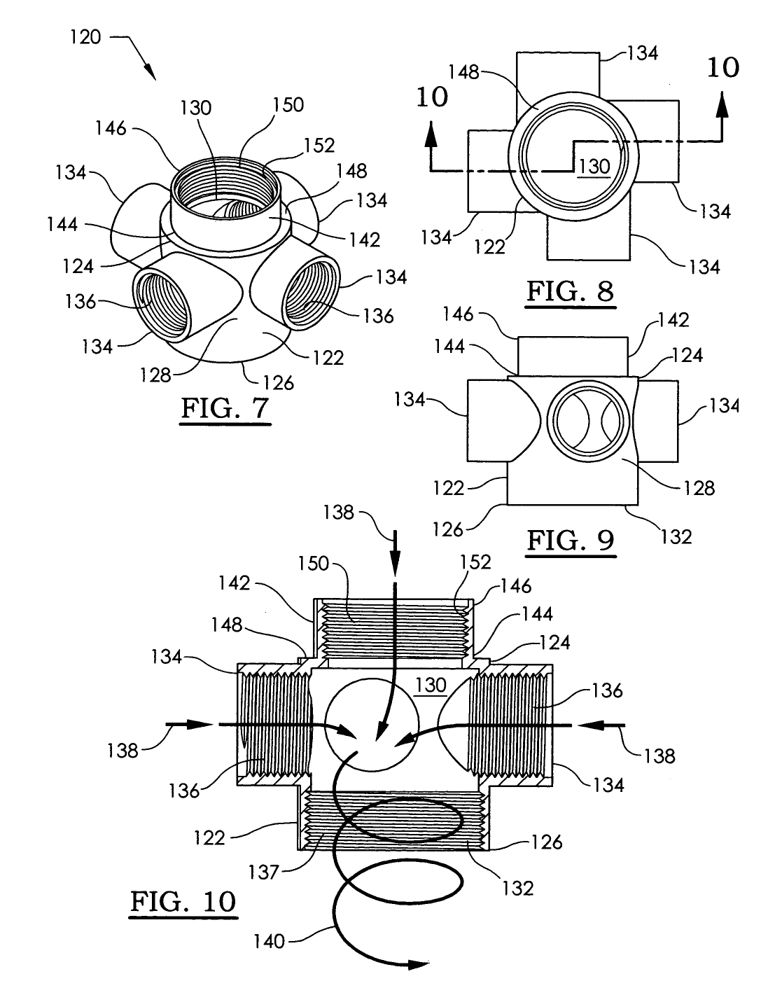

Referring now to FIGS. 7, 8, 9, and 10, a second embodiment of the fluid vortex manifold is shown at 120, and is similar to the fluid vortex manifold 20 described above in that fluid vortex manifold 120 comprises a hollow circular cylindrical shell 122 extending between top 124 and bottom 126 ends. The shell 122 has a predetermined diameter, a periphery 128, a shell central axis, and a chamber 130 adapted to receive the fluid material. The shell 122 has a single outlet 132 at the bottom end 126. The outlet 132 is adapted to discharge all of the fluid material from the chamber 130.

A plurality of hollow circular cylindrical peripheral inlets 134 is disposed around the shell periphery 128. The peripheral inlets 134 have a diameter less than the shell predetermined diameter. The peripheral inlets 134 are generally tangential to the shell 122, and communicate with the shell chamber 130. The peripheral inlets 134 are adapted to receive fluid material from the fluid sources and direct the fluid material tangentially into the shell chamber 130, forming a vortex and suction, so as to preclude a backflow of the fluid material through the peripheral inlets 134. Each peripheral inlet 134 has an inlet central axis. The shell central axis and the inlet central axis define skew lines. The inlet central axis of each peripheral inlet 134 is in the same-handed relation to the shell central axis when viewed along the shell central axis.

Female pipe threads 136 are provided for connecting the peripheral inlets 134 to the fluid sources. Similarly, female pipe threads 137 are provided for connecting the shell outlet 132 to the fluid receptacle. In use, fluid material, shown by arrows 138, will flow from the fluid sources through the peripheral inlets 134 and enter the shell chamber 130 tangentially, forming a vortex, shown by arrows 140. The vortex 140 creates suction, thereby precluding a backflow of fluid material 138 through the peripheral inlets. Fluid material 138 will then flow out of the shell chamber 130 into the fluid receptacle.

Fluid vortex manifold 120 differs from fluid vortex manifold 20 in that a hollow circular cylindrical nozzle 142 extends between a proximal end 144 adjacent the shell top end 124 and a distal end 146. The nozzle 142 has a diameter less than the shell predetermined diameter. The nozzle 142 communicates with the shell chamber 130. An annular shoulder 148 extends between the shell top end 124 and the nozzle proximal end 144. The nozzle 142 has a nozzle inlet 150 at the distal end 146. Female threads 152 extend from the nozzle distal end 146 toward the nozzle proximal end 144, for attaching a threaded plumbing fitting (not shown) to the nozzle inlet 150 so as to connect the nozzle inlet 150 to one of the fluid sources.

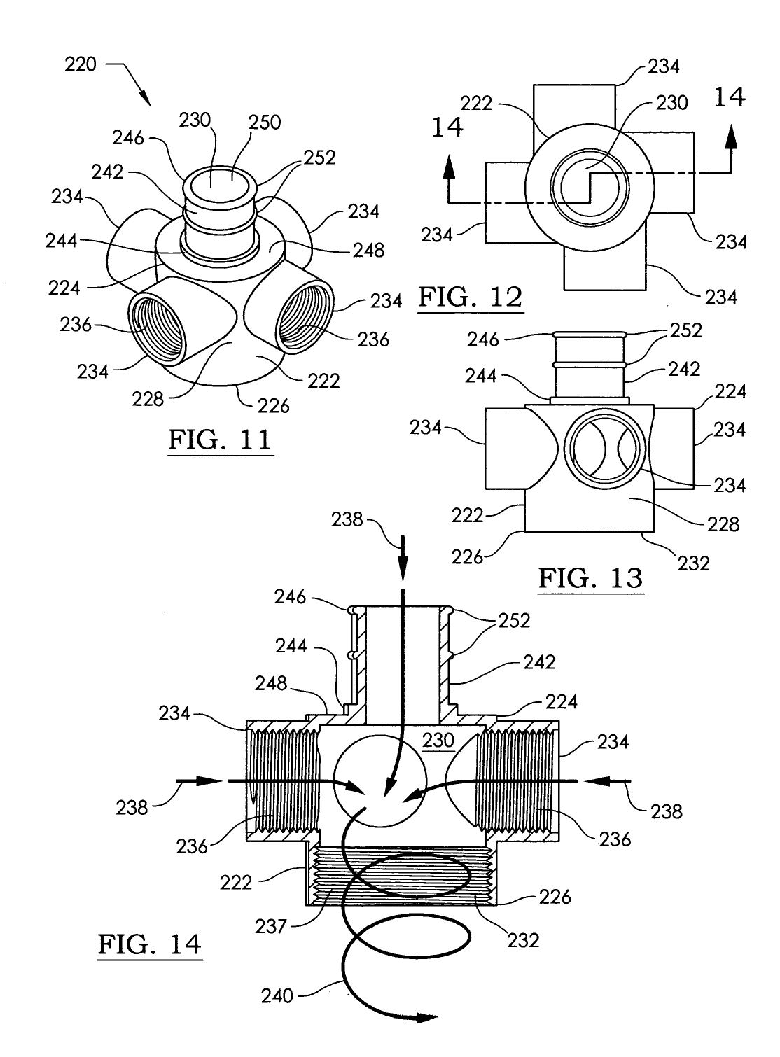

Turning now to FIGS. 11, 12, 13, and 14, a third embodiment of the fluid vortex manifold is shown at 220, and is similar to the fluid vortex manifold 20 described above in that fluid vortex manifold 220 comprises a hollow circular cylindrical shell 222 extending between top 224 and bottom 226 ends. The shell 222 has a predetermined diameter, a periphery 228, a shell central axis, and a chamber 230 adapted to receive the fluid material. The shell 222 has a single outlet 232 at the bottom end 226. The outlet 232 is adapted to discharge all of the fluid material from the chamber 230.

A plurality of hollow circular cylindrical peripheral inlets 234 is disposed around the shell periphery 228. The peripheral inlets 234 have a diameter less than the shell predetermined diameter. The peripheral inlets 234 are generally tangential to the shell 222, and communicate with the shell chamber 230. The peripheral inlets 234 are adapted to receive fluid material from the fluid sources and direct the fluid material tangentially into the shell chamber 230, forming a vortex and suction, so as to preclude a backflow of the fluid material through the peripheral inlets 234. Each peripheral inlet 234 has an inlet central axis. The shell central axis and the inlet central axis define skew lines. The inlet central axis of each peripheral inlet 234 is in the same-handed relation to the shell central axis when viewed along the shell central axis.

Female pipe threads 236 are provided for connecting the peripheral inlets 234 to the fluid sources. Similarly, female pipe threads 237 are provided for connecting the shell outlet 232 to the fluid receptacle. In use, fluid material, shown by arrows 238, will flow from the fluid sources through the peripheral inlets 234 and enter the shell chamber 230 tangentially, forming a vortex, shown by arrows 240. The vortex 240 creates suction, thereby precluding a backflow of fluid material 238 through the peripheral inlets. Fluid material 238 will then flow out of the shell chamber 230 into the fluid receptacle.

Fluid vortex manifold 220 differs from fluid vortex manifold 20 in that a hollow circular cylindrical hose barb 242 extends between a proximal end 244 adjacent the shell top end 224 and a distal end 246. The hose barb 242 has a diameter less than the shell predetermined diameter. The hose barb 242 communicates with the shell chamber 230. An annular shoulder 248 extends between the shell top end 224 and the hose barb proximal end 244. The hose barb 242 has a hose barb inlet 250 at the hose barb distal end 246. At least one annular ridge 252 is provided on the hose barb 242 at the distal end 246. Typically, a second annular ridge 252 is disposed intermediate the proximal 244 and distal 246 ends. The ridges 252 are for attaching a hose (not shown) to the hose barb inlet 250 so as to connect the hose barb inlet 250 to one of the fluid sources.

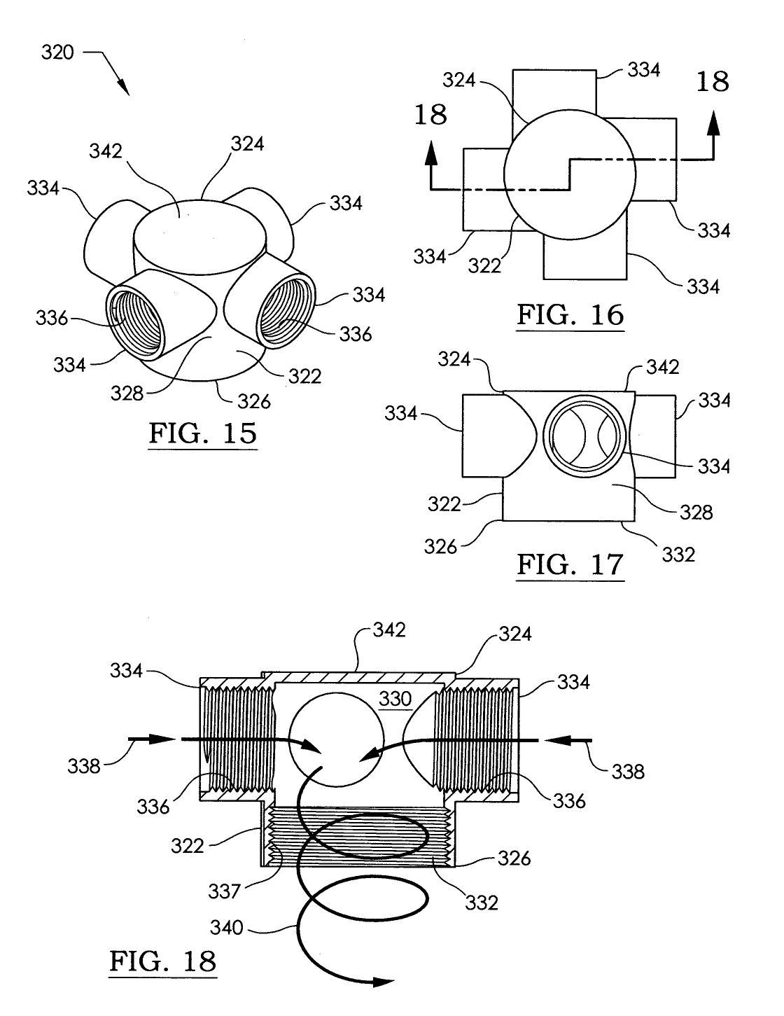

Referring now to FIGS. 15, 16, 17, and 18, a fourth embodiment of the fluid vortex manifold is shown at 320, and is similar to the fluid vortex manifold 20 described above in that fluid vortex manifold 320 comprises a hollow circular cylindrical shell 322 extending between top 324 and bottom 326 ends. The shell 322 has a predetermined diameter, a periphery 328, a shell central axis, and a chamber 330 adapted to receive the fluid material. The shell 322 has a single outlet 332 at the bottom end 326. The outlet 332 is adapted to discharge all of the fluid material from the chamber 330.

A plurality of hollow circular cylindrical peripheral inlets 334 is disposed around the shell periphery 328. The peripheral inlets 334 have a diameter less than the shell predetermined diameter. The peripheral inlets 334 are generally tangential to the shell 322, and communicate with the shell chamber 330. The peripheral inlets 334 are adapted to receive fluid material from the fluid sources and direct the fluid material tangentially into the shell chamber 330, forming a vortex and suction, so as to preclude a backflow of the fluid material through the peripheral inlets 334. Each peripheral inlet 334 has an inlet central axis. The shell central axis and the inlet central axis define skew lines. The inlet central axis of each peripheral inlet 334 is in the same-handed relation to the shell central axis when viewed along the shell central axis.

Female pipe threads 336 are provided for connecting the peripheral inlets 334 to the fluid sources. Similarly, female pipe threads 337 are provided for connecting the shell outlet 332 to the fluid receptacle. In use, fluid material, shown by arrows 338, will flow from the fluid sources through the peripheral inlets 334 and enter the shell chamber 330 tangentially, forming a vortex, shown by arrows 340. The vortex 340 creates suction, thereby precluding a backflow of fluid material 338 through the peripheral inlets. Fluid material 338 will then flow out of the shell chamber 330 into the fluid receptacle.

Fluid vortex manifold 320 differs from fluid vortex manifold 20 in that a plate 342 is sealingly attached to the shell periphery 328 at the top end 324, so as to close the chamber 330 at the top end 324.

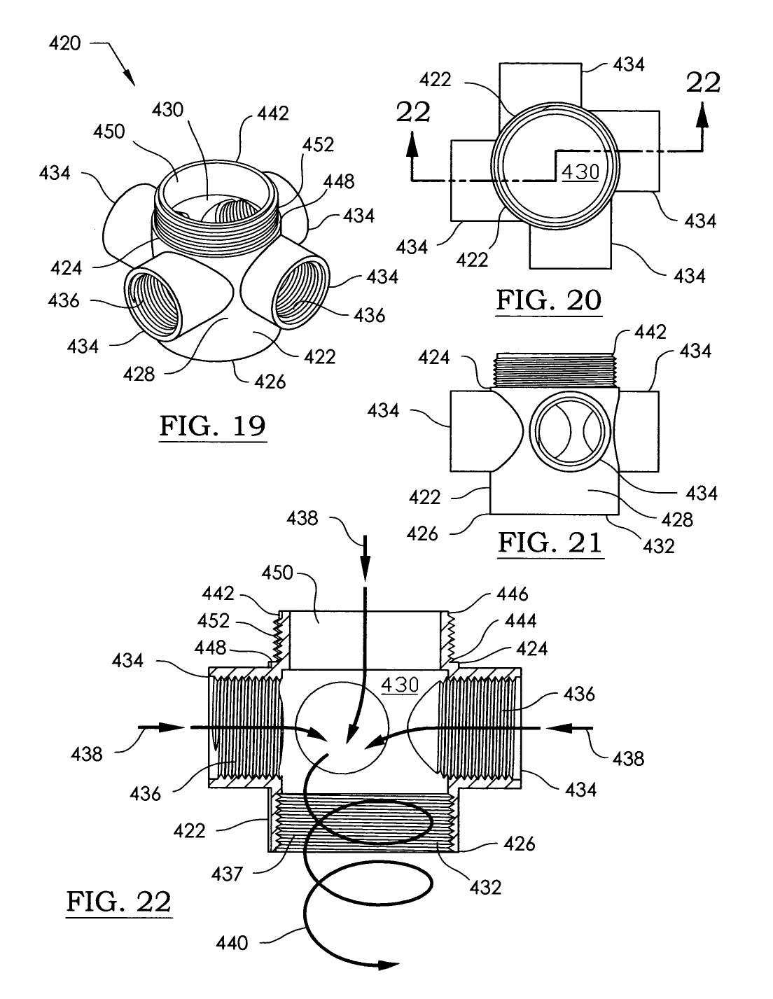

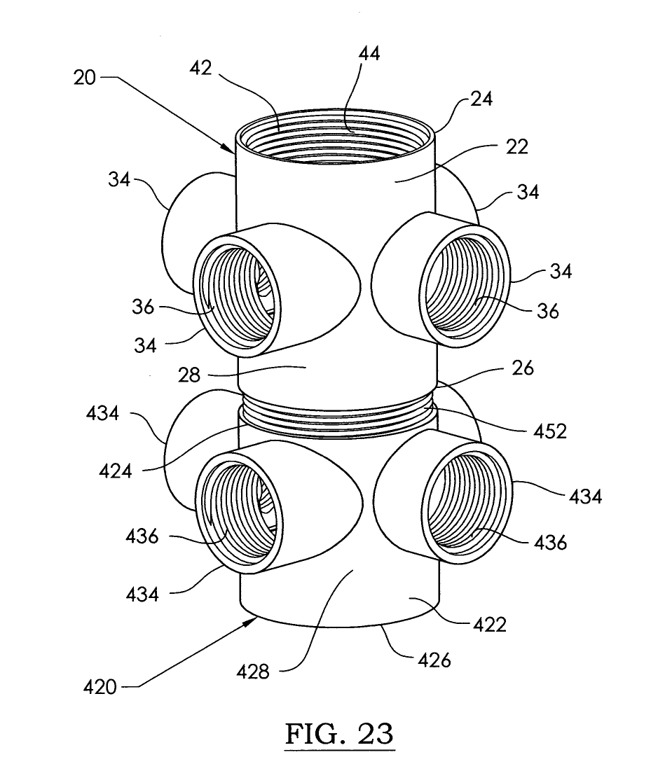

Referring now to FIGS. 19, 20, 21, and 22, a fifth embodiment of the fluid vortex manifold is shown at 420, and is similar to the fluid vortex manifold 20 described above in that fluid vortex manifold 420 comprises a hollow circular cylindrical shell 422 extending between top 424 and bottom 426 ends. The shell 422 has a predetermined diameter, a periphery 428, a shell central axis, and a chamber 430 adapted to receive the fluid material. The shell 422 has a single outlet 432 at the bottom end 426. The outlet 432 is adapted to discharge all of the fluid material from the chamber 430.

A plurality of hollow circular cylindrical peripheral inlets 434 is disposed around the shell periphery 428. The peripheral inlets 434 have a diameter less than the shell predetermined diameter. The peripheral inlets 434 are generally tangential to the shell 422, and communicate with the shell chamber 430. The peripheral inlets 434 are adapted to receive fluid material from the fluid sources and direct the fluid material tangentially into the shell chamber 430, forming a vortex and suction, so as to preclude a backflow of the fluid material through the peripheral inlets 434. Each peripheral inlet 434 has an inlet central axis. The shell central axis and the inlet central axis define skew lines. The inlet central axis of each peripheral inlet 434 is in the same-handed relation to the shell central axis when viewed along the shell central axis.

Female pipe threads 436 are provided for connecting the peripheral inlets 434 to the fluid sources. Similarly, female pipe threads 437 are provided for connecting the shell outlet 432 to the fluid receptacle. In use, fluid material, shown by arrows 438, will flow from the fluid sources through the peripheral inlets 434 and enter the shell chamber 430 tangentially, forming a vortex, shown by arrows 440. The vortex 440 creates suction, thereby precluding a backflow of fluid material 438 through the peripheral inlets. Fluid material 438 will then flow out of the shell chamber 430 into the fluid receptacle.

Fluid vortex manifold 420 differs from fluid vortex manifold 20 in that a hollow circular cylindrical nozzle 442 extends between a proximal end 444 adjacent the shell top end 424 and a distal end 446. The nozzle 442 has a diameter less than the shell predetermined diameter. The nozzle 442 communicates with the shell chamber 430. An annular shoulder 448 extends between the shell top end 424 and the nozzle proximal end 444. The nozzle 442 has a nozzle inlet 450 at the distal end 446. Male threads 452 extend from the nozzle distal end 446 toward the nozzle proximal end 444, for attaching a threaded plumbing fitting (not shown) to the nozzle inlet 450 so as to connect the nozzle inlet 450 to one of the fluid sources.

The versatility of the invention is shown in FIG. 23, wherein the first and fifth embodiments are assembled together. In this manner, any number of combinations of any of the embodiments of the invention can be connected.

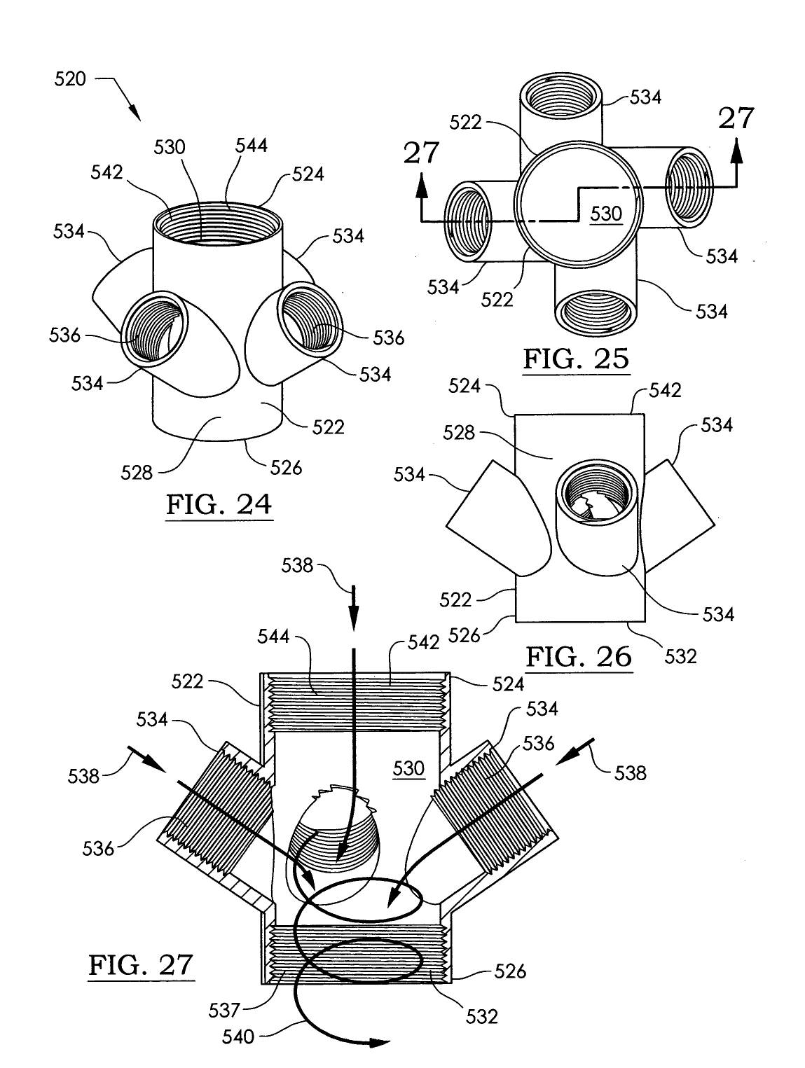

Referring now to FIGS. 24, 25, 26, and 27, a sixth embodiment of the fluid vortex manifold is shown at 520, and is similar to the fluid vortex manifold 20 described above in that fluid vortex manifold 520 comprises a hollow circular cylindrical shell 522 extending between top 524 and bottom 526 ends. The shell 522 has a predetermined diameter, a periphery 528, a shell central axis, and a chamber 530 adapted to receive the fluid material 538. The shell 522 has a top inlet 542 at the top end 524, and a single outlet 532 at the bottom end 526. The outlet 532 is adapted to discharge all of the fluid material 538 from the chamber 530.

A plurality of hollow circular cylindrical peripheral inlets 534 is disposed around the shell periphery 528. The peripheral inlets 534 have a diameter less than the shell predetermined diameter. The peripheral inlets 534 are generally tangential to the shell 522, and communicate with the shell chamber 530. The peripheral inlets 534 are adapted to receive fluid material 538 from the fluid sources and direct the fluid material 538 tangentially into the shell chamber 530, forming a vortex and suction, so as to preclude a backflow of the fluid material 538 through the peripheral inlets 534. Each peripheral inlet 534 has an inlet central axis. The shell central axis and the inlet central axis define skew lines, meaning they are not parallel, do not intersect, and do not lie in the same plane. The inlet central axis of each peripheral inlet 534 is in the same-handed relation to the shell central axis when viewed along the shell central axis. This means that in the top view, FIG. 25, all of the peripheral inlets 534 enter the shell 522 in a counterclockwise direction. Thus, fluid material 538 from each peripheral inlet 534 rotates in the same direction to create the vortex. It is to be understood that the peripheral inlets 534 can enter the shell 522 in a clockwise direction.

Female pipe threads 536 are provided for connecting the peripheral inlets 534 to the fluid sources. Similarly, female pipe threads 537 are provided for connecting the shell outlet 532 to the liquid receptacle. Female pipe threads 544 are provided at the top inlet 542 for attaching a threaded plumbing fitting (not shown) to the top inlet 542 so as to connect the top inlet 542 to one of the fluid sources. The female threads 536, 537, and 544 represent the preferred embodiment. It is to be understood for every embodiment of the invention, that male threads, hose barbs, bolted flanges, bell and spigot joints, and soldered, welded, or cemented joints are alternatives which fall within the scope of the appended claims.

Fluid vortex manifold 520 differs from fluid vortex manifold 20 in that the projected angle of the skew lines, defined by the shell central axis and the inlet central axis, is not a right angle, but is an acute angle as shown in FIGS. 26 and 27. This angled entry enhances the flow characteristics of the fluid material 538 entering the shell chamber 530.

Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention. Details of the structure may be varied substantially without departing from the spirit of the invention and the exclusive use of all modifications that will come within the scope of the appended claims is reserved.

### PARTS LIST

### Fluid Vortex Manifold

| PART | | |
|---|---|---|
| NO. | | DESCRIPTION |
| | 20 | fluid vortex manifold |
| | 22 | cylindrical shell |
| | 24 | shell top end |
| | 26 | shell bottom end |
| | 28 | periphery |
| | 30 | chamber |
| | 32 | outlet |
| | 34 | peripheral inlets |
| | 36 | inlet pipe threads |
| | 37 | outlet pipe threads |
| | 38 | fluid material |
| | 40 | vortex |
| | 42 | top inlet |
| | 44 | top inlet pipe threads |
| | 120 | fluid vortex manifold |
| | 122 | cylindrical shell |
| | 124 | shell top end |
| | 126 | shell bottom end |
| | 128 | periphery |
| | 130 | chamber |
| | 132 | outlet |
| | 134 | peripheral inlets |
| | 136 | inlet pipe threads |
| | 137 | outlet pipe threads |
| | 138 | fluid material |
| | 140 | vortex |
| | 142 | nozzle |
| | 144 | nozzle proximal end |
| | 146 | nozzle distal end |
| | 148 | annular shoulder |
| | 150 | nozzle inlet |
| | 152 | nozzle inlet pipe threads |
| | 220 | fluid vortex manifold |
| | 222 | cylindrical shell |
| | 224 | shell top end |
| | 226 | shell bottom end |
| | 228 | periphery |
| | 230 | chamber |
| | 232 | outlet |
| | 234 | peripheral inlets |
| | 236 | inlet pipe threads |
| | 237 | outlet pipe threads |
| | 238 | fluid material |
| | 240 | vortex |
| | 242 | hose barb |
| | 244 | hose barb proximal end |
| | 246 | hose barb distal end |
| | 248 | annular shoulder |
| | 250 | hose barb inlet |
| | 252 | annular ridges |
| | 320 | fluid vortex manifold |
| | 322 | cylindrical shell |
| | 324 | shell top end |
| | 326 | shell bottom end |
| | 328 | periphery |
| | 330 | chamber |
| | 332 | outlet |
| | 334 | peripheral inlets |
| | 336 | inlet pipe threads |
| | 337 | outlet pipe threads |
| | 338 | fluid material |
| | 340 | vortex |
| | 342 | plate |
| | 420 | fluid vortex manifold |
| | 422 | cylindrical shell |
| | 424 | shell top end |
| | 426 | shell bottom end |
| | 428 | periphery |
| | 430 | chamber |
| | 432 | outlet |
| | 434 | peripheral inlets |
| | 436 | inlet pipe threads |
| | 437 | outlet pipe threads |
| | 438 | fluid material |
| | 440 | vortex |
| | 442 | nozzle |
| | 444 | nozzle proximal end |
| | 446 | nozzle distal end |
| | 448 | annular shoulder |
| | 450 | nozzle inlet |
| | 452 | nozzle inlet pipe threads |
| | 520 | fluid vortex manifold |
| | 522 | cylindrical shell |
| | 524 | shell top end |
| | 526 | shell bottom end |
| | 528 | periphery |
| | 530 | chamber |
| | 532 | outlet |
| | 534 | peripheral inlets |
| | 536 | inlet pipe threads |
| | 537 | outlet pipe threads |
| | 538 | fluid material |
| | 540 | vortex |
| | 542 | top inlet |
| | 544 | top inlet pipe threads |

The embodiments of the invention in which an exclusive property or privilege is claimed are defined as follows:

1. A fluid vortex manifold, for use in connection with a fluid drain plumbing system having a plurality of fluid sources supplying fluid material including liquids, gases, and solid particles, and a receptacle for receiving the fluid material from the fluid sources, the fluid vortex manifold comprising:
(a) a hollow circular cylindrical shell extending between top and bottom ends, the shell having a predetermined diameter, a periphery, a shell central axis, a chamber adapted to receive the fluid material, and a single outlet at the bottom end, the outlet being adapted to discharge all of the fluid material from the chamber;
(b) a plurality of hollow circular cylindrical peripheral inlets disposed around the shell periphery, the peripheral inlets having a diameter less than the shell predetermined diameter, the peripheral inlets being generally tangential to the shell, the peripheral inlets each having an inlet central axis, the shell central axis and the inlet central axis defining skew lines, the inlet central axis of each peripheral inlet being in the same handed relation to the shell central axis when viewed along the shell central axis, the peripheral inlets communicating with the shell chamber, the peripheral inlets being adapted to receive fluid material from the fluid sources and direct the fluid material tangentially into the shell chamber, forming a vortex and suction, so as to preclude a backflow of the fluid material through the peripheral inlets;
(c) inlet connecting means for connecting the peripheral inlets to the fluid sources; and
(d) outlet connecting means for connecting the shell outlet to the fluid receptacle, so that fluid material will flow out of the shell chamber into the fluid receptacle.

2. The fluid vortex manifold of claim 1, wherein the fluid vortex manifold is made from a material selected from the group consisting of polymeric thermoplastic resin, polymeric thermoset resin, iron, carbon steel, stainless steel, copper, brass, bronze, monel, aluminum and concrete.

3. The fluid vortex manifold of claim 2, wherein the inlet connecting means further comprises threads at the peripheral inlets for attaching threaded plumbing fittings to the peripheral inlets.

4. The fluid vortex manifold of claim 2, wherein the outlet connecting means further comprises threads at the outlet for attaching a threaded plumbing fitting to the outlet.

5. The fluid vortex manifold of claim 2, wherein the shell further comprises:
(a) a top inlet at the top end; and
(b) threads at the top inlet for attaching a threaded plumbing fitting to the top inlet so as to connect the top inlet to a one of the fluid sources.

6. The fluid vortex manifold of claim 2, further comprising:
(a) a hollow circular cylindrical nozzle extending between a proximal end adjacent the shell top end and a distal end, the nozzle having a diameter less than the shell predetermined diameter, the nozzle communicating with the shell chamber;
(b) an annular shoulder extending between the shell top end and the nozzle proximal end;
(c) a nozzle inlet at the nozzle distal end; and
(d) threads extending from the nozzle distal end toward the nozzle proximal end, for attaching a threaded plumbing fitting to the nozzle inlet so as to connect the nozzle inlet to a one of the fluid sources.

7. The fluid vortex manifold of claim 2, further comprising:
(a) a hollow circular cylindrical hose barb extending between a proximal end adjacent the shell top end and a distal end, the hose barb having a diameter less than the shell predetermined diameter, the hose barb communicating with the shell chamber;
(b) an annular shoulder extending between the shell top end and the hose barb proximal end;
(c) a hose barb inlet at the hose barb distal end; and
(d) at least one annular ridge on the hose barb for attaching a hose to the hose barb inlet so as to connect the hose barb inlet to a one of the fluid sources.

8. The fluid vortex manifold of claim 2, further comprising a plate sealingly attached to the shell periphery at the top end, so as to close the chamber at the top end.

9. A fluid vortex manifold, for use in connection with a fluid drain plumbing system having a plurality of fluid sources supplying fluid material including liquids, gases, and solid particles, and a receptacle for receiving the fluid material from the fluid sources, the fluid vortex manifold comprising:
(a) a hollow circular cylindrical shell extending between top and bottom ends, the shell having a predetermined diameter, a periphery, a shell central axis, a chamber adapted to receive the fluid material, and a single outlet at the bottom end, the outlet being adapted to discharge all of the fluid material from the chamber;
(b) a plurality of hollow circular cylindrical peripheral inlets disposed around the shell periphery, the peripheral inlets having a diameter less than the shell predetermined diameter, the peripheral inlets being generally tangential to the shell, the peripheral inlets each having an inlet central axis, the shell central axis and the inlet central axis defining skew lines, the inlet central axis of each peripheral inlet being in the same handed relation to the shell central axis when viewed along the shell central axis, the peripheral inlets communicating with the shell chamber, the peripheral inlets being adapted to receive fluid material from the fluid sources and direct the fluid material tangentially into the shell chamber, forming a vortex and suction, so as to preclude a backflow of the fluid material through the peripheral inlets;
(c) threads at the peripheral inlets for attaching threaded plumbing fittings to the peripheral inlets to connect the peripheral inlets to the fluid sources; and
(d) threads at the outlet for attaching a threaded plumbing fitting to the outlet to connect the shell outlet to the fluid receptacle, so that fluid material will flow out of the shell chamber into the fluid receptacle.

10. The fluid vortex manifold of claim 9, wherein the fluid vortex manifold is made from a material selected from the group consisting of polymeric thermoplastic resin, polymeric thermoset resin, iron, carbon steel, stainless steel, copper, brass, bronze, monel, aluminum and concrete.

11. The fluid vortex manifold of claim 10, wherein the shell further comprises:
(a) a top inlet at the top end; and
(b) threads at the top inlet for attaching a threaded plumbing fitting to the top inlet so as to connect the top inlet to a one of the fluid sources.

12. The fluid vortex manifold of claim 10, further comprising:
(a) a hollow circular cylindrical nozzle extending between a proximal end adjacent the shell top end and a distal end, the nozzle having a diameter less than the shell predetermined diameter, the nozzle communicating with the shell chamber;
(b) an annular shoulder extending between the shell top end and the nozzle proximal end;
(c) a nozzle inlet at the nozzle distal end; and
(d) threads extending from the nozzle distal end toward the nozzle proximal end, for attaching a threaded plumbing fitting to the nozzle inlet so as to connect the nozzle inlet to a one of the fluid sources.

13. The fluid vortex manifold of claim 10, further comprising:
(a) a hollow circular cylindrical hose barb extending between a proximal end adjacent the shell top end and a distal end, the hose barb having a diameter less than the shell predetermined diameter, the hose barb communicating with the shell chamber;
(b) an annular shoulder extending between the shell top end and the hose barb proximal end;
(c) a hose barb inlet at the hose barb distal end; and
(d) at least one annular ridge on the hose barb for attaching a hose to the hose barb inlet so as to connect the hose barb inlet to a one of the fluid sources.

14. The fluid vortex manifold of claim 10, further comprising a plate sealingly attached to the shell periphery at the top end, so as to close the chamber at the top end.

15. A fluid vortex manifold, for use in connection with a fluid drain plumbing system having a plurality of fluid sources supplying fluid material including liquids, gases, and solid particles, and a receptacle for receiving the fluid material from the fluid sources, the fluid vortex manifold comprising:
(a) a hollow circular cylindrical shell extending between top and bottom ends, the shell having a predetermined diameter, a periphery, a shell central axis, a chamber adapted to receive the fluid material, and a single outlet at the bottom end, the outlet being adapted to discharge all of the fluid material from the chamber;
(b) a plurality of hollow circular cylindrical peripheral inlets disposed around the shell periphery, the peripheral inlets having a diameter less than the shell predetermined diameter, the peripheral inlets being generally tangential to the shell, the peripheral inlets each having an inlet central axis, the shell central axis and the inlet central axis defining skew lines, the inlet central axis of each peripheral inlet being in the same handed relation to the shell central axis when viewed along the shell central axis, the peripheral inlets communicating with the shell chamber, the peripheral inlets being adapted to receive fluid material from the fluid sources and direct the fluid material tangentially into the shell chamber, forming a vortex and suction, so as to preclude a backflow of the fluid material through the peripheral inlets;
(c) the fluid vortex manifold being made from a material selected from the group consisting of polymeric thermoplastic resin, polymeric thermoset resin, iron, carbon steel, stainless steel, copper, brass, bronze, monel, aluminum and concrete;
(d) threads at the peripheral inlets for attaching threaded plumbing fittings to the peripheral inlets to connect the peripheral inlets to the fluid sources; and
(e) threads at the outlet for attaching a threaded plumbing fitting to the outlet to connect the shell outlet to the fluid receptacle, so that fluid material will flow out of the shell chamber into the fluid receptacle.

16. The fluid vortex manifold of claim 15, wherein the shell further comprises:
(a) a top inlet at the top end; and
(b) threads at the top inlet for attaching a threaded plumbing fitting to the top inlet so as to connect the top inlet to a one of the fluid sources.

17. The fluid vortex manifold of claim 15, further comprising:
(a) a hollow circular cylindrical nozzle extending between a proximal end adjacent the shell top end and a distal end, the nozzle having a diameter less than the shell predetermined diameter, the nozzle communicating with the shell chamber;
(b) an annular shoulder extending between the shell top end and the nozzle proximal end;
(c) a nozzle inlet at the nozzle distal end; and
(d) threads extending from the nozzle distal end toward the nozzle proximal end, for attaching a threaded plumbing fitting to the nozzle inlet so as to connect the nozzle inlet to a one of the fluid sources.

18. The fluid vortex manifold of claim 15, further comprising:
(a) a hollow circular cylindrical hose barb extending between a proximal end adjacent the shell top end and a distal end, the hose barb having a diameter less than the shell predetermined diameter, the hose barb communicating with the shell chamber;
(b) an annular shoulder extending between the shell top end and the hose barb proximal end;
(c) a hose barb inlet at the hose barb distal end; and
(d) at least one annular ridge on the hose barb for attaching a hose to the hose barb inlet so as to connect the hose barb inlet to a one of the fluid sources.

19. The fluid vortex manifold of claim 15, further comprising a plate sealingly attached to the shell periphery at the top end, so as to close the chamber at the top end.
